(19) United States
(12) Patent Application Publication
(10) Pub. No.: US 2024/0397985 A1
(43) Pub. Date: Dec. 5, 2024

(54) PUFFED EDIBLE PRODUCT COMPRISING WHOLE GRAINS

(71) Applicant: STRAUSS FRITO LAY LTD, Petah Tivka (IL)

(72) Inventors: Nadegda Vesker, Beer Sheva (IL); Maayan Kogan, Rehovot (IL)

(21) Appl. No.: 18/691,244

(22) PCT Filed: Sep. 7, 2022
(86) PCT No.: PCT/IL2022/050975

§ 371 Date: Mar. 12, 2024

(30) Foreign Application Priority Data
Sep. 14, 2021 (IL) 286412

(51) Int. Cl. A23L 7/174; A23L 7/191; A23L 27/10; A23L 27/30

(52) U.S. Cl. CPC A23L 7/174; A23L 7/191; A23L 27/10; A23L 27/30

(57) ABSTRACT

Some embodiments relate to a puffed edible products that contain more than 10 wt % of whole grains, and methods of their manufacture. The puffed edible products contain a puffed edible core that contains at least 25 wt % of whole grains and a flavoring composition that coats the surface of the edible core.

### CROSS-REFERENCE TO RELATED APPLICATIONS

This application is a national phase filing under 35 C.F.R. § 371 of and claims priority to PCT Patent Application No. PCT/IL2022/050975, filed on Sep. 7, 2022, which claims the priority benefit under 35 U.S.C. § 119 of Israeli Patent Application No. 286412, filed on Sep. 14, 2021, the contents of which are hereby incorporated in their entireties by reference.

### TECHNOLOGICAL FIELD

The present disclosure concerns puffed edible products, more specifically puffed edible products that comprise whole grains, and methods of their manufacture.

### BACKGROUND

Puffed edible products are typically based on one or more grains, that undergo puffing (i.e. aeration or expansion) in order to obtain a porous, aerated crispy product. The puffed products, which are typically snacks, can come in a variety of forms, e.g. puffed grains in particulate form (such as puffed wheat, puffed quinoa, puffed rice, etc.) which are produced by puffing the individual grains in free form, puffed crackers in which the grains are compressed and heat-puffed to form the crackers, or puffed pellets which are obtained by puff-extrusion of a wet grain-based dough.

Puff-extrusion of wet grain-based dough is highly sensitive to the formulation of the paste, as various properties of the paste, such as viscosity, fiber content, fat content, water content, etc. can have a significant effect on the shape and properties of the final puffed product.

With increase in awareness of the nutritional and health benefits of reducing intake of processed grains, there is also an increased interest in providing edible products which comprise, or are based on, whole grains. However, up to date, puff-extrusion of grain-based pastes has been limited to grain types which are relatively low in fibers and desirable fats, as high content of these components in the paste are known to significantly limit expansion capability of the grain, resulting in a dense and palate unpleasing texture. Hence, traditionally, such products are produced from processed grains, from which at least part of the fibers and beneficial fats are removed. Such removal typically damages the nutritional values of the final product. These processed grains are not only easier to process, but are often cheaper than whole grains, making these economically favorable for snack manufacturers, while sacrificing the nutritional values of the final product.

### GENERAL DESCRIPTION

In view of increased interest in healthier foods and recognition of the benefit of whole grains consumption, it would be beneficial to replace at least a portion of the processed grains in puffed edible products with whole grains which have undergone minimal or no processing. The present disclosure provides puffed edible products that can be consumed as healthier alternatives to standard grain-based snacks.

Thus, in one of its aspects, the present disclosure provides an edible product that comprises an extruded puffed grain-based core and a flavoring composition. The extruded puffed grain-based core constitutes between about 30 and about 50 wt % of the edible product, and comprises at least one whole grain in an amount of at least 25 wt % of the core weight. The flavoring composition covers the external surface of the puffed core and is at least partially absorbed by the puffed core, and constitutes up to about 70 wt % of the edible product.

By another aspect, there is provided an edible product that comprises a grain-based extruded puffed core, having an external surface covered by a flavoring composition, the flavoring composition being at least partially absorbed into the puffed core, the edible product comprising at least 10 wt % of at least one whole grain and up to 70 wt % of the flavoring composition.

As noted, the edible product comprises a grain-based puffed core that constitutes about 30-50 wt % of the edible product's weight, while the flavoring composition constitutes up to 70 wt % of the edible product's weight. Accordingly, the puffed core comprises at least one whole grain being at least 25 wt % of its weight, which is at least about 10 wt % of the edible product's weight.

In other words, the edible product includes a core, that is puffed by extrusion, the core contains at least 25 wt % of its weight of one or more whole grains (or, alternatively, the edible product has at least 10 wt % of its weight being said at least one whole grain). The core is typically grain-based, and is coated or covered by a flavoring composition to obtain the edible product, the flavoring composition covers at least a part, typically the entire external surface of the core. As the core is puffed, the flavoring composition, which is typically a liquid or a paste that is applied onto the core, is also at least partially absorbed into the core. In the edible product, the extruded puffed core constitutes between about 30 and about 50 wt % of the weight of the edible product, while the flavoring composition constitutes up to 70 wt % of the weight of the edible product.

The term puffed core means to denote an edible aerated structure, e.g. porous, expanded or aerated structure, in which the starches in the grain are expanded to generate a perforated or porous sponge-like structure. A grain-based puffed core is a puffed core that comprises one or more grains as main components, e.g. at least 70 wt % of the core being one or more grains. Extruded puffed core means to denote a puffed core which is produced by extruding a wet paste containing the composition of the core (typically comprising one or more grains), hence applying high pressure and high temperature onto the core in a confined space of an extruder. Application of pressure and temperature causes formation of steam within the grains in the wet paste, and once extruded out of the confined space—the difference in pressures causes the steam to rapidly expand the starches in the grains, thereby puffing the grains to obtain a puffed core. The high temperature causes the starches in the grain to gelatinize, and once cooled down, form a solid, crispy porous structure.

By some embodiments, the density of the extruded puffed core is between about 25 and 40 g/liter.

The puffed core comprises at least about 25 wt % of at least one whole grain. According to some embodiments, the puffed core comprises at least about 30 wt % of its weight of at least one whole grain. In other embodiments, the puffed core comprises the at least one whole grain in an amount of between about 25 wt % and 40 wt %, e.g. 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt % or even 40 wt % of the core weight.

Alternatively, by some embodiments, the edible product comprises at least about 10 wt % of its weight of at least one whole grain, e.g. between about 10 wt % and 20 wt % of the total weight of the edible product is said at least one whole grain.

Whole grains are grains of cereals or pseudocereals which contain the entire components of the grain, i.e. the endosperm, germ and bran. Unlike processed grains frequently used in the snack industry, which are typically processes in order to remove the germ and bran (being the high-fiber, high-fat components of the grain), whole grains contain relatively high amounts of beneficial fibers (e.g. dietary or soluble fibers), nutrients, and beneficial fats.

According to some embodiments, the whole grain is selected from whole oats, whole corn, whole rice, whole wheat, whole-grain rye, buckwheat, millet, whole barley, spelt, quinoa, sorghum, teff, amaranth, durum, and mixtures thereof.

By some embodiments, the whole grain is whole oats, and the puffed core comprises at least about 25 wt % of whole oats, typically between about 25 wt % and 40 wt % whole oats (between about 10 wt % and 20 wt % of the weight of the edible product).

The puffed core, by some embodiments, can comprise at least one additional grain, being different from said whole grain, the additional grain can be a whole grain or a non-whole grain.

The at least one additional grain can be selected from whole corn, corn, whole rice, rice, whole wheat, wheat, whole-grain rye, rye, buckwheat, millet, whole barley, barley, spelt, quinoa, sorghum, teff, amaranth, durum, and mixtures thereof.

By other embodiments, the additional grain can be selected from one or more of corn, rice, wheat, rye, buckwheat, millet, barley, spelt, quinoa, sorghum, teff, amaranth, durum, and mixtures thereof.

The puffed core, by some embodiments, comprises between about 30 and 75 wt % of additional grain(s). Alternatively, the edible product comprises between about 20 and 40 wt % of additional grain(s).

According to a particular embodiment, the puffed core comprises whole oats, corn and rice. The puffed core may, according to some embodiments, comprise whole oats in an amount ranging between about 25 wt % and 40 wt % of the core weight, corn in an amount ranging between about 20 wt % and about 40 wt % of the core weight, and rice in an amount ranging between about 20 wt % and 40 wt % of the core weight. Alternatively, the edible product, by some embodiments, comprises whole oats in an amount of between about 10 wt % and 20 wt % of the edible product weight, corn in an amount of between about 10 wt % and about 20 wt % of the edible product weight, and rice in an amount of between about 10 wt % and 20 wt % of the edible product weight.

By some embodiments, the puffed core is gluten-free. According to other embodiments, the edible product is gluten-free.

As noted, the puffed core is covered by a flavoring composition. As the core is puffed, i.e. has a porous structure, the flavoring composition is absorbed or penetrates into at least part of the volume of the puffed core. The flavoring composition is typically provided in liquid or paste form, and comprises one or more flavoring agents mixed with or dispersed into a carrier edible liquid (e.g. oil).

As noted, the edible product comprises up to about 70 wt % of flavoring composition. By some embodiments, the edible product comprises between about 40 wt % and about 70 wt % of the flavoring composition.

By some embodiments, the density of the edible product ranges between about 65 and 100 g/liter.

According to some embodiments, the flavoring composition can comprise one or more vegetable-based and/or dairy-based flavoring agents. According to other embodiments, the flavoring composition can comprise one or more of the following edible components: oils, spices, salting agents, sweeteners (natural and non-natural), flavoring agents, cocoa powder, cocoa butter, coffee powder, coffee extract, milk powder, cheese powder, whey powder, stabilizers, antioxidants, preservatives, vitamins, protein supplements, nutritional fibers, pH modifiers, emulsifiers, nutritional additives, flavor enhancers, flavor masking agents, flavoring extracts, food coloring (natural or non-natural), and any combination thereof.

By some embodiments, the flavoring composition comprises peanut butter. As peanut butter typically comprises about 50% peanut solids and about 50% oil (e.g. peanut oil), the peanut butter can function as a flavoring agent within a carrier edible fluid, or can function both as a flavoring agent and carrier edible liquid.

According to some embodiments, the flavoring composition comprises at least 35 wt % peanut butter. According to other embodiments, the flavoring composition comprises between about 40 and about 55 wt % peanut butter. Alternatively, the edible product comprises at least about 15 wt % peanut butter, e.g. between about 15 and 28 wt % peanut butter.

According to some other embodiments, the flavoring composition comprises peanut powder, e.g. between about 8 and about 15 wt % of the flavoring composition (alternatively, between about 4 and 12 wt % of peanut powder out of the weight of the edible product). The peanut powder may have an average particle size of less than about 200 micrometers (μm), resulting in a creamy, non-granular mouthfeel. Further, addition of peanut powder to the flavoring composition increases the content of peanut solids in the flavoring composition, thus reducing the absolute content of oil in the flavoring composition.

By some embodiments, the flavoring composition can comprise up to 80 wt % oil, e.g. between about 50 and about 75 wt % of the weight of the flavoring composition (or between about 40 and about 55 wt % of the edible product's weight). The oil can be selected from peanut oil, corn oil, sunflower seeds oil, safflower oil, olive oil, rice bran oil, rapeseed oil, grape seed oil, sesame seed oil, flax oil, palm oil, cotton seed oil, walnut oil, pumpkin seed oil, soybean oil, avocado oil, and any mixture thereof. According to some embodiments, the oil is selected as to be rich in oleic acid. In case the flavoring composition comprises peanut butter, at least a portion of the oil content in the flavoring composition originates from the peanut butter. Hence, when peanut butter is used as a component in the flavoring composition, the total amount of oil includes the endogenous oil originating from the peanuts.

By some embodiments, the flavoring composition comprises up to about 15 wt % of one or more natural sweeteners, and/or up to about 0.3 wt % one or more artificial sweeteners.

Exemplary natural sweeteners are sugar, honey, glucose syrup, molasses, maple syrup, agave syrup, coconut sugar, palm sugar, stevia extract, monk fruit juice/extract, yacon syrup, corn syrup, rice syrup, and others. Exemplary artificial sweeteners are sorbitol, mannitol, erythritol, xylitol, arabitol, maltitol, lactitol, allulose, acesulfame potassium, aspartame, cyclamate, sucralose, thaumatin, isomalt, saccharine, and others.

The puffed core may, by some embodiments, be a baked puffed core, i.e. a puffed core which has undergone drying or baking (roasting) after extrusion in order to reduce its water content, typically to below 2 wt % water, or even below 1 wt % water.

The edible product is typically characterized by a crunchy, yet dissolvable, mouthfeel. Crunchiness can be evaluated by the mechanical properties of the edible product. Accordingly, by some embodiments, the edible product can sustain a maximal compression load of at least about 45 N, for example a maximal compression load of between about 45 N and 60 N. Unless otherwise indicated, the maximal load value was obtained by carrying out a compression test between two parallel plates in a Texture Analyzer TAI (Lloyd), and a compression rate of 50 mm/min (up to 50% depth of the product thickness).

According to some embodiments, the edible product is in the form of pellets. The pellets can be a solid form (i.e. a full cylindrical form), can be hollow (e.g. hollow cylinder), or can have one or more through-holes as to form a pattern or a design (e.g. flower-like, wheel-like, latticework, mesh-like, etc.). The pellet can have any shape, substantially planar or voluminous (i.e. non-planar, 3-dimensional shape), e.g. cylindrical, cubic, pentagonal, hexagonal, pyramidal, polygonal, oval, round, ball, dumbbell, irregular shape, or any other shape.

According to some embodiments, the pellets are substantially cylindrical.

By some embodiments, the puffed core has a substantially uniform external surface. In other words, the outer surface of the external core is substantially homogenous in structure, without significant protrusions and/or surface cavities observable by eye.

The extruded puffed grain-based core is also a distinct aspect of this disclosure. Hence, according to another aspect, there is provided a grain-based edible extruded puffed core which is (on its own) or is suitable for preparation of an edible product, the puffed core comprises at least one whole grain in an amount of at least 25 wt % of the core weight.

As a person of the art would appreciate, embodiments of the edible product aspect relating to the extruded puff core described hereinabove are also embodiments of the extruded puffed core aspect.

By another aspect, there is provided a process for preparing an edible product as disclosed herein. The process comprises puff-extruding a paste composition comprising at least one whole grain in an amount of at least 25 wt % to obtain a pre-core; drying the pre-core to obtain an extruded puffed core having a water content of at most 2 wt %; and adding a flavoring composition in a liquid or paste form to the puffed core and permitting the flavoring composition to cover the external surface of the puffed core and be at least partially absorbed thereinto, to thereby obtain an edible product having the puffed core constituting between about 30 and about 50 wt % of the edible product, and the flavoring composition constituting up to about 70 wt % of the edible product.

Puff-extrusion of pastes comprising relatively large, e.g. above 10 wt %, whole grains has been considered problematic. Without being bound by theory, whole grains are typically rich in fibers and natural sugars, which together form a sturdy and stable cellular structure of the grain, and thus have been considered difficult to puff. Further, the relatively high fat content in the whole grain acts as a lubricant upon application of pressure and high temperature, preventing the grain particles to physically interlock during extrusion-processing, hence making it difficult to obtain and maintain a puffed structure.

The inventors of the presently disclosed subject-matter have surprisingly found that by application of certain conditions in the extrusion process, puffed edible products that contain high amounts of whole grains can be obtained.

Thus, by some embodiments, the temperature of the paste during puff-extruding is at least about 120° C., e.g. between about 120° C. and about 180° C.

According to some embodiments, puff-extruding is carried out at a pressure of at least 80 bar, e.g. between about 80 and about 160 bar. According to some embodiments, puff-extruding is carried out at a pressure of between about 100 and about 150 bar.

According to some embodiments, the paste composition is maintained under the extrusion conditions within the extruder for a period time of at least about 3 seconds, e.g. between about 5 and about 10 seconds.

By some embodiments, the process comprises mixing at least about 25 wt % of at least one whole grain, at most 73 wt % of one or more additional grains, and between about 2 wt % and 5 wt % water, to obtain the grain-based paste.

By some embodiments, the grain-based paste comprises whole oats, corn, rice and water. The paste can comprise, by some embodiments, whole oats flakes in an amount of between about 25 wt % and 40 wt %, corn powder in an amount of between about 20 wt % and about 40 wt %, rice powder in an amount of between about 20 wt % and 40 wt %, and water in an amount of between about 2 wt % and 5 wt %.

According to some embodiments, the whole oats have an average particle size of about 2,000-3,000 μm. By other embodiments, the corn powder has an average particle size of about 200-350 μm. By yet other embodiments, the rice powder has an average particle size of about 300-500 μm.

After forming the pre-cores and drying/baking them to reduce their moisture content, the puffed cores are flavored. By some embodiments, addition of the flavoring composition to the puffed cores can be carried out by any suitable method known to a person of skill, for example by dipping, tumbling, spraying, mixing, etc.

In some embodiments, the process further comprises maintaining the edible product at ambient temperature of a period of time of between about 1 hour and 2 weeks, typically between about 12 hours and 1 week, to permit at least partial absorption or penetration of the flavoring composition into the puffed core.

In some embodiments, the process further comprises packing a plurality of edible products as described herein within a sealed, user-openable packaging.

By another aspect, the disclosure provides a packed edible product, comprising a sealed, user-openable package holding a plurality of the edible products as disclosed herein.

The package can be flexible, semi-flexible or rigid, and be of any suitable shape and form. By some embodiments, the package is in the form of a food-grade sealed bag, for example a plastic sheet bag or laminated aluminum-foil bag. The package can typically be heat- or adhesive-sealed, and may or may not contain re-closing means permitting closing the package once opened by the user (e.g. zip-lock arrangement, multi-use adhesive strip, closing adhesive tab, etc.).

The package, by some embodiments, may be filled with an inert gas, e.g. nitrogen, in order to displace oxygen from the packaging and prolong the shelf life of the edible product.

By some embodiments, the package can comprise one or more moisture absorbing means.

As used herein, the term about is meant to encompass deviation of +10% from the specifically mentioned value of a parameter, such as temperature, pressure, concentration, etc.

Whenever a numerical range is indicated herein, it is meant to include any cited numeral (fractional or integral) within the indicated range. The phrases ranging ranges between a first indicate number and a second indicate number and “ranging/ranges from” a first indicate number “to” a second indicate number are used herein interchangeably and are meant to include the first and second indicated numbers and all the fractional and integral numerals therebetween. It should be noted that where various embodiments are described by using a given range, the range is given as such merely for convenience and brevity and should not be construed as an inflexible limitation on the scope of the invention. Accordingly, the description of a range should be considered to have specifically disclosed all the possible sub-ranges as well as individual numerical values within that range.

Throughout this specification and the claims which follow, unless the context requires otherwise, the word comprise, and variations such as comprises and comprising, will be understood to imply the inclusion of a stated integer or step or group of integers or steps but not the exclusion of any integer or step or group of integers and steps.

Generally it is noted that the term . . . at least one . . . as applied to any component of a composition or process of this disclosure should be read to encompass one, two, three, four, five, or more different occurrences of said component in the composition or process.

It is appreciated that certain features of this disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B show an edible product according to an embodiment of this disclosure.

FIGS. 2A-2B show extruded puffed cores produced according to a comparative example process, with process parameters of conventional extrusion processing.

FIGS. 3A-3C show edible product samples used for mechanical testing: FIGS. 3A-3B show commercial products with a core containing 100% corn (maize); FIG. 3C shows an edible product of this disclosure.

### DETAILED DESCRIPTION OF EMBODIMENTS

### Example 1—Preparation of an Edible Product Containing Whole Grains

A batch of 250 kg grain-based paste was prepared by mixing 30-35 wt % whole oats flakes (average particle size of 2,500-3,000 μm), 25-35 wt % corn powder (average particle size of 200-350 μm), and 25-35 wt % rice powder (average particle size 300-500 μm), with about 5 liters of water.

The paste was puff-extruded through a pellets-shaped die, to obtain substantially cylindrical puffed pre-cores, having a length of about 3-5 cm and diameter of 1-1.5 cm. The temperature of the paste within the extruder was about 130° C. and motor torque of about 1200 N/m, and the paste was processed within the extruder for 5-10 seconds before extrusion through the shaped die.

The pre-cores were dried at elevated temperature to reduce their moisture content to below about 1 wt %, thereby obtaining the puffed cores, having a density of 30-35 g/liter.

Then, the puffed cores where mixed with the flavoring composition, that included 40-55 wt % of peanut butter, about 10 wt % peanut powder, oil and seasoning, to obtain substantially homogenous coating of the external surface of the core with the flavoring composition.

The product was then maintained in air-tight bags, for a period of time of 24-72 hours, to permit the flavoring composition to at least partially be absorbed by the puffed core. The density of the edible product was 75-88 g/liter.

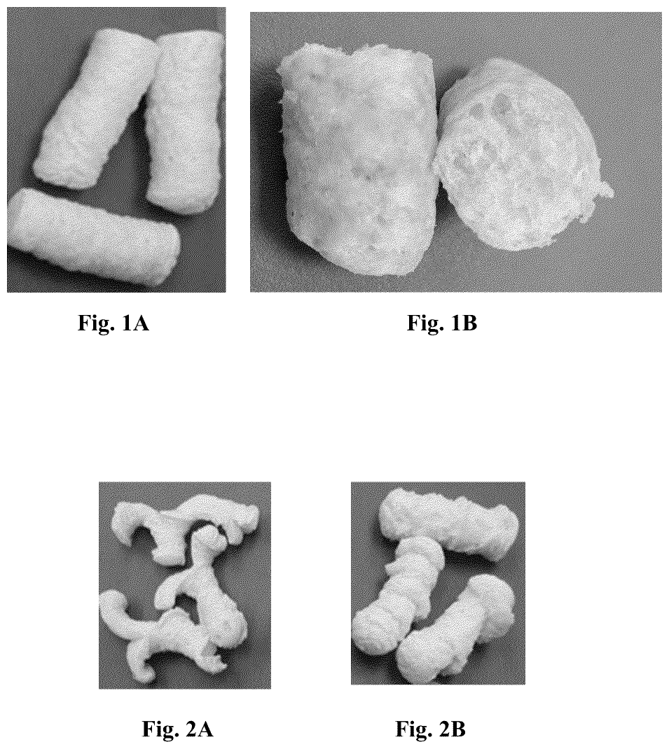

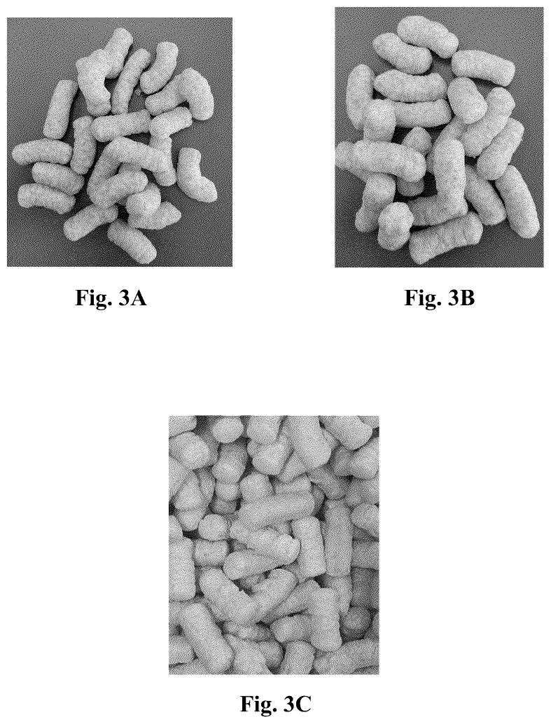

As can be seen in FIGS. 1A-1B, the edible product is substantially cylindrical in shape, with a homogenous pellet size, and maintains its aerated, porous structure although comprising about 15 wt % of whole oats.

### COMPARATIVE EXAMPLES

Batches prepared from pastes comprising below 25 wt % whole oats and above 35 wt % whole oats (FIGS. 2A-2B, respectively) were puff-extruded. Preparation and extrusion conditions were similar to those of Example 1.

As can be seen in FIGS. 2A-2B, the product that comprised below 25 wt % whole oats was uneven and non-homogenous in shape and size, while the product containing a high amount of whole oats did not substantially puff, with the core split and/or disintegrating.

### Mechanical Testing

Samples from Example 1 have been tested for mechanical properties in comparison to two commercial puff-extruded edible products in which the puffed core is made of 100% corn (out of the grains' components in the core) and coated by a peanut butter-based coating. All sampled edible products had a cylindrical shape, with similar external dimensions, as can be seen in FIGS. 3A-3C.

The samples were tested under compression conditions, using a compression test between two parallel plates in a Texture analyzer TAI (Lloyd), and a compression rate of 50 mm/min (up to 50% depth of the product thickness). The maximal compression load of 10 edible products of each type were tested. The average maximal compression loads obtained are shown in Table 1. As can be seen from Table 1, the addition of app. 30 wt % whole grain oats to the puffed core resulted in a product having comparable, and even improved, mechanical properties when compared to products which are 100% maize-based. Hence, edible products of Example 1 showed comparable, and times improved, crunchiness, contributing to the pleasant mouthfeel of the product, however containing high content of whole grains in the product.

TABLE 1
Maximal compression load of edible products

| | Average maximal | Standard |
|---|---|---|
| Product | compression load (N)* | deviation |
| Commercial product 1 | 41 | 2.5 |
| Commercial product 2 | 54 | 5.7 |
| Product according to example 1 | 56 | 4.3 |

*average and standard deviation calculated for 10-samples

### Comparative Tasting

Samples of commercial products 1 and 2 and the product of example 1 were taste-tested on groups of children, aged 5-12 years (60-80 testers). As can be seen in Table 2, the test panel showed no significant preference to a specific product, indicating that although the product of example has contained about 15 wt % of whole oats, no significant differences in flavor were sensed by the testers.

TABLE 2
Taste tests in children aged 5-12 years (in % out of testers)

| | Taste | | | Average |
|---|---|---|---|---|
| Product | Good | Medium | Bad | score* |
| Commercial product 1 | 97% | 3% | 0 | 8.1 |
| Commercial product 2 | 89% | 8% | 3% | 7.9 |
| Product according to example 1 | 90% | 10% | 0 | 7.8 |

*on a scale of 1-9

1. An edible product comprising:
an extruded puffed grain-based core constituting between about 30 and about 50 wt % of the edible product, the puffed core comprising at least one whole grain in an amount of at least about 25 wt % of the core weight and between about 30 and 75 wt % of at least one additional grain, different from said at least one whole grain; and
a flavoring composition covering the external surface and at least partially absorbed by the puffed core and constituting up to about 70 wt % of the edible product.

2. (canceled)

3. The edible product of claim 1, wherein said whole grain is selected from whole oats, whole corn, whole rice, whole wheat, whole-grain rye, buckwheat, millet, whole barley, spelt, quinoa, sorghum, teff, amaranth, durum, and mixtures thereof.

4. The edible product of claim 1, wherein the whole grain is of whole oats.

5. (canceled)

6. (canceled)

7. The edible product of claim 1, wherein said additional grain is selected from corn, rice, wheat, rye, buckwheat, millet, barley, spelt, quinoa, sorghum, teff, amaranth, durum, and mixtures thereof.

8. The edible product of as claim 1, wherein said puffed core comprises whole oats, corn and rice.

9. The edible product of claim 8, wherein the puffed core comprises whole oats in an amount of between about 25 wt % and 40 wt % of the core weight, corn in an amount of between about 20 wt % and about 40 wt % of the core weight, and rice in an amount of between about 20 wt % and 40 wt % of the core weight.

10. The edible product of claim 9, being gluten-free.

11. The edible product of claim 1, wherein the flavoring composition comprises peanut butter.

12. The edible product of claim 11, wherein said peanut butter constituted at least 35 wt % of said flavoring composition.

13. (canceled)

14. The edible product of claim 11, wherein the flavoring composition comprises between about 8 and about 15 wt % of peanut powder.

15. The edible product of a claim 1, wherein the flavoring composition comprises between about 50 wt % and about 80 wt % of the weight of the flavoring composition.

16. The edible product of claim 1, wherein the flavoring composition comprises up to about 15 wt % of one or more natural sweeteners and/or up to about 0.3 wt % of one or more artificial sweeteners.

17. (canceled)

18. (canceled)

19. (canceled)

20. An edible product, comprising a grain-based extruded puffed core, the core having an external surface covered by a flavoring composition, the flavoring composition being at least partially absorbed into the puffed core, the edible product comprising at least 10 wt % of at least one whole grain, between about 20 and 40 wt % of at least one additional grain different from said whole grain, and up to 70 wt % of the flavoring composition.

21. The edible product of claim 20, wherein said whole grain is selected from whole oats, whole corn, whole rice, whole wheat, whole-grain rye, buckwheat, millet, whole barley, spelt, quinoa, sorghum, teff, amaranth, durum, and mixtures thereof.

22. The edible product of claim 21, wherein said whole grain is whole oats.

23. (canceled)

24. (canceled)

25. The edible product of claim 20, comprising whole oats, corn and rice.

26. The edible product of claim 25, comprising whole oats in an amount of between about 10 wt % and 20 wt %, corn in an amount of between about 10 wt % and about 20 wt %, and rice in an amount of between about 10 wt % and 20 wt %.

27. The edible product of claim, wherein the flavoring composition comprises between about 15 wt % and 28 wt % of peanut butter.

28. (canceled)

29. (canceled)

30. An extruded puffed core for an edible product, the puffed core comprising at least one whole grain in an amount of at least 25 wt % of the core weight and between about 30 and 75 wt % of the core weight of at least one additional grain, different from said at least one whole grain.

31. (canceled)

32. The puffed core of claim 30, wherein said whole grain is selected from whole oats, whole corn, whole rice, whole wheat, whole-grain rye, buckwheat, millet, whole barley, spelt, quinoa, sorghum, teff, amaranth, durum, and mixtures thereof.

33. The puffed core of claim 30, wherein said whole grain is whole oats.

34. (canceled)

35. (canceled)

36. The puffed core of claim 30, wherein said additional grain is selected from corn, rice, wheat, rye, buckwheat, millet, barley, spelt, quinoa, sorghum, teff, amaranth, durum, and mixtures thereof.

37. The puffed core of claim 30, comprising whole oats, corn and rice.

38. The puffed core of claim 37, comprising whole oats in an amount of between about 25 wt % and 40 wt % of the core weight, corn in an amount of between about 20 wt % and about 40 wt % of the core weight, and rice in an amount of between about 20 wt % and 40 wt % of the core weight.

39. (canceled)

40. (canceled)

41. (canceled)

42. (canceled)

43. (canceled)

44. (canceled)

45. (canceled)
